(19) United States
(12) Patent Application Publication
(10) Pub. No.: US 2011/0314001 A1
(43) Pub. Date: Dec. 22, 2011

(54) PERFORMING QUERY EXPANSION BASED UPON STATISTICAL ANALYSIS OF STRUCTURED DATA

(75) Inventors: Charles Edward Jacobs, Seattle, WA (US); John C. Platt, Bellevue, WA (US); Johnson Tan Apacible, Mercer Island, WA (US)

(73) Assignee: Microsoft Corporation, Redmond, WA (US)

(21) Appl. No.: 12/818,227

(22) Filed: Jun. 18, 2010

(51) Int. Cl. G06F 17/30

(52) U.S. Cl. 707/722; 707/767; 707/E17.014; 707/E17.017

(57) ABSTRACT

A method described herein includes an act of receiving a query from a user, wherein the query is configured to search over a plurality of documents belonging to a particular domain. The method also includes an act of providing data to the user for display on a display screen of a computing apparatus, wherein the data is provided based at least in part upon a statistical analysis undertaken with respect to structured data pertaining to the particular domain, wherein the structured data is based at least in part upon data included in the plurality of documents.

### BACKGROUND

The amount of information available on the World Wide Web has grown exponentially such that billions of documents are available by way of the Internet. Such explosive growth of web information has not only created a crucial challenge for search engine companies in connection with handling large scale data, but has also increased the difficulty for a user to manage his or her information needs. For instance, it may be difficult for a user to compose a succinct and precise query to represent his or her information needs.

Instead of pushing the burden of generating succinct search queries to the user, search engines have been configured to provide increasingly relevant search results. More particularly, a search engine can be configured to retrieve documents relative to a user query by comparing attributes of documents together with other features, such as anchor text, and can return documents that best match the query. Today's search engines can also consider previous user queries, user location, current events, amongst other information in connection with providing the most relevant search results to a user query. The user is typically shown a ranked list of universal resource locators (URLs) in response to providing a query to the search engine.

Moreover, some search engines are configured with functionality to provide a user with alternate queries to a query provided by such user. Such alternate queries can be configured to correct possible spelling mistakes made by the user, can be configured to provide the user with information that is related but non-identical to information retrieved by way of the query provided by the user, etc. For instance, if a user types a query “msg” to a search engine, the user may be provided with alternative potential queries such as “Madison Square Garden,” “monosodium glutamate,” amongst others. Generally, these alternate queries are conventionally based at least in part upon queries previously submitted by users. In a general case where a user wishes to search over each web page indexed by the search engine, such provision of alternate query works effectively. If, however, the user wishes to search over semi-structured data in a particular domain, oftentimes alternate queries provided by search engines are not helpful. For instance, contents of structured data may include terms that do not come to mind when users proffer queries to the search engines. For instance, recipes can be considered semi-structured data, since most recipes have a somewhat common format (a list of ingredients, instructions for adding ingredients together, etc.). Many users may wish to search for recipes that include chicken. The searchers, however, may not think to search for chicken with the spice cilantro, even though several recipes exist for cilantro chicken. Thus, since users have not thought to previously search for such terms, the search engine is not configured to provide alternate queries to aid searchers in locating certain documents that include semi-structured data.

### SUMMARY

The following is a brief summary of subject matter that is described in greater detail herein. This summary is not intended to be limiting as to the scope of the claims.

Described herein are various technologies pertaining to performing query expansion based upon a received user query and a statistical analysis of structured data. With more specificity, many data sources on the World Wide Web include semi-structured data. Semi-structured data is data that generally has some form of consistent structure across data sources, but does not have identical structure across data sources. An example of semi-structured data that can be found on web pages is recipes. For instance, recipes generally include a list of ingredients, an amount of such ingredients, and particular steps to undertake to complete a dish. Different web sites that specialize in recipes, however, may structure the presentation of the recipes differently. Another example of semi-structured data is resumes. Generally, a resume will include a name of an individual, contact information, education of the individual, professional experience of the individual, among other attributes. Again, however, two different resumes may be structured differently even though they include several of the same attributes.

Semi-structured data with respect to a particular domain (e.g., recipes, resumes, etc.) can be extracted and formatted in accordance with a schema that is common for a plurality of data sources that include the semi-structured data. Thus, a first recipe from a first data source can be structured in a substantially similar manner to a second recipe from a second data source by formatting content of the recipe in accordance with a common schema. This extraction of semi-structured data and formatting thereof results in creation of structured data, wherein the structured data includes a plurality of records. The structured data may be analyzed to remove duplicate records, attributes can be normalized and other processing can be undertaken to generate “clean” structured data for a particular domain. In an example, the resulting structured data can be stored in a file such as an XML file.

This structured data can be retained and utilized in connection with query expansion when a user submits a query searching for documents in a domain that corresponds to the structured data. For example, a statistical analysis can be undertaken on structured data belong to the domain in connection with building a recommendation system for the domain. When a user submits a query pertaining to such domain, the recommendation system can be used to perform query expansion on the received query. In other words, query expansion can be undertaken based at least in part upon content of the structured data and not solely upon queries previously submitted by other users. This allows query alterations to be provided to the user that are configured to return relevant search results to the user, as such alterations are based upon content of the structured data. Thus, query alteration can be treated as a recommendation problem. Specifically, using the statistics of the structured data, recommendations can be generated pertaining to which query terms are likely to co-occur with other query terms in the data. Associated query terms can be suggested to the user upon receipt of the user query, and the user may then modify the query to retrieve a relevant record/document.

In another embodiment, a recommendation system built by way of statistical analysis over the aforementioned structured data can be used to pre-generate a query suggestion dictionary, which not only suggests expansion to the query but also maps particular queries to one or more records in the structured data and/or one or more documents from which a record in the structured data originated. For example, commonly issued queries with respect to the domain corresponding to the structured data can be provided as an input to a recommendation system, which can a) perform query expansion on the provided queries; and b) directly map the common queries and/or query alterations to one or more records in the structured data. This suggestion dictionary may then be included in an online system such that if a user proffers a query that is included in the suggestion dictionary, appropriate records can be immediately returned to the user that issued such query. If the query is not triggered by the suggestion dictionary, then such query can be provided to a search engine that can perform a search over a particular document corpus based at least in part upon the query.

Other aspects will be appreciated upon reading and understanding the attached figures and description.

### BRIEF DESCRIPTION OF THE DRAWINGS

FIG. 1 is a functional block diagram of an exemplary system that facilitates providing a user with query alterations based at least in part upon a statistical analysis of structured data.

FIG. 2 is a flow diagram illustrating an exemplary methodology for generating structured data from semi-structured data retrieved from a plurality of data sources.

FIG. 3 is a flow diagram that illustrates an exemplary methodology for performing query expansion based at least in part upon statistical analysis of structured data.

FIG. 4 is a diagram illustrating utilization of a recommendation system to provide suggested queries to a user.

FIG. 5 is an exemplary system that facilitates building a suggestion dictionary for a particular domain based at least in part upon a statistical analysis of structured data corresponding to the domain.

FIG. 6 is an exemplary system that facilitates providing a user with records and/or documents through utilization of a suggestion dictionary.

FIG. 7 is an exemplary suggestion dictionary.

FIG. 8 is a flow diagram that illustrates an exemplary methodology for generating a suggestion dictionary based at least in part upon statistical analysis of structured data.

FIG. 9 is a flow diagram that illustrates an exemplary methodology for providing a user with records and/or documents through utilization of a suggestion dictionary.

FIG. 10 is an exemplary computing system.

### DETAILED DESCRIPTION

Various technologies pertaining to query expansion will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

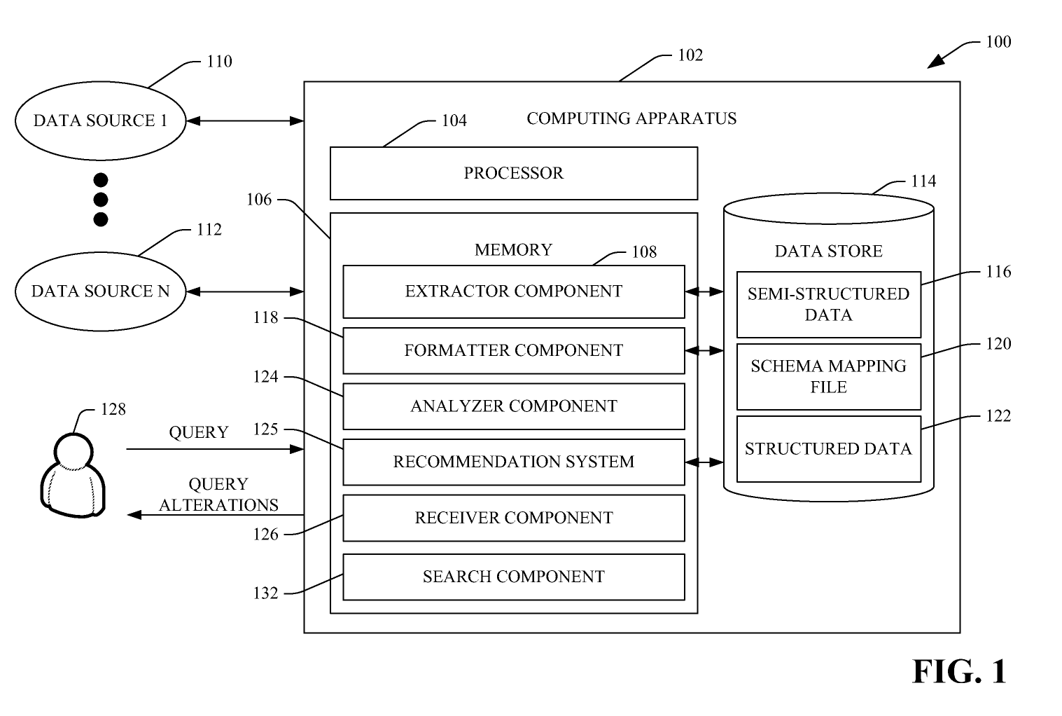

With reference to FIG. 1, an exemplary system 100 that facilitates generating query alterations based at least in part upon a statistical analysis of structured data is illustrated. The system 100 is configured to treat query expansion as a recommendation problem based upon an analysis of data that originates from documents that are desirably searched over. Specifically, the system 100 is configured to aid users in connection with searching for documents that comprise semi-structured data. Semi-structured data is data that has at least some semblance of structure that is common across multiple different providers of data, wherein the data belongs to a certain domain (e.g., topic). The structure of data in semi-structured data, however, may be non-identical across the multiple different providers of the data.

Examples of semi-structured data include recipes, resumes, computing devices, etc. For instance, most recipes posted on web pages have some structure corresponding thereto and include many common attributes across recipes provided by different web pages. For example, generally, recipes include ingredients, an amount of ingredient to utilize at a certain step, and instructions for completing a dish such as cooking time, etc. Furthermore, resumes (regardless of the provider of the resumes) generally include the name of an individual, contact information of the individual, education of the individual, and professional experience of the individual amongst other attributes. Similarly, web pages that describe computing devices generally include attributes such as hard drive space on a computing device, an amount of memory on the computing device, processor speed, etc. This semi-structured data can be extracted from certain documents (web pages) and can be processed such that the semi-structured data from various data sources is formatted in accordance with a schema that is common across the data sources. As will be described in greater detail herein, the resulting structured data can be subject to statistical analysis, and query alterations can be provided to users based at least in part upon this statistical analysis. Operation of the system 100 will now be described in greater detail.

The system 100 includes a computing apparatus 102 that comprises a processor 104 and a memory 106, wherein the memory 106 comprises a plurality of components that are executable by the processor 104. Pursuant to an example, the computing apparatus 102 may be a server in a server farm that is associated with a search engine. Of course, the computing apparatus 102 may be a distributed computing device such that a plurality of servers can be represented by the computing apparatus 102.

The components in the memory 106 include an extractor component 108 that is configured to extract semi-structured data with respect to a particular domain from one or more data sources 110-112. In an example, the data sources 110-112 may be web sites that are accessible to the computing apparatus 102 by way of some suitable network connection. In another example, the data sources 110-112 may be databases that are accessible to the computing apparatus 102 by way of a network connection or that reside locally on the computing apparatus 102. The data sources 110-112 may comprise documents such as web pages that include semi-structured data pertaining to a particular domain. For example, a domain can be considered as a particular topic or collection of related items. Thus, a domain may be recipes, resumes, computing devices, etc. The extractor component 108 is configured to extract the semi-structured data from the different data sources 110-112. In an example, the extractor component 108 may be configured to pull the semi-structured data from one or more of the data sources 110-112. Alternatively, one or more of the data sources 110-112 may be configured to push the semi-structured data to the extractor component 108.

The extractor component 108, upon receipt of the semi-structured data, can be configured to validate such data and/or “clean” such data. For example, the extractor component 108 can analyze the semi-structured data to ensure that it belongs to a particular domain of interest. In another example, the extractor component 108 can ensure that the data source providing the semi-structured data is an approved provider of such data. The computing apparatus 102 may also comprise a data store 114, wherein the extractor component 108 can cause the cleaned validated semi-structured data 116 to be retained in the data store 114. The semi-structured data 116 can be partitioned in such a way that semi-structured data from different data sources are separated.

The memory 106 also includes a formatter component 118 that processes the semi-structured data 116 to cause such data to be transformed into structured data, which can be retained in the data store 114. Specifically, the formatter component 118 can cause the semi-structured data 116 to be processed to conform to a common schema. The data store 114 may include a schema mapping file 120 with respect to a particular one of the data sources 110-112 and can utilize such schema mapping file 120 to cause semi-structured data from the data source corresponding to this schema mapping file 120 to be transformed into the structured data 122.

The structured data 122 can include a plurality of records, wherein the records correspond to records in the semi-structured data 116. Thus, each record in the structured data 122 can correspond to a record in the semi-structured data 116 with a difference being that each record in the structured data 122 corresponds to a common schema. Thus, an example record in the structured data 122 may be a recipe.

The formatter component 118 may then perform further processing on the structured data 122. For example, the formatter component 118 can locate duplicate records in the structured data 122 and remove one or more redundant records from the structured data 122. Furthermore, the formatter component 118 can process the structured data 122 to normalize values/attributes of records in the structured data 122. Upon completion of such processing, the structured data 120 can be stored in the data stored 114 as a file such as an XML file.

The memory 108 may also comprise an analyzer component 124 that can perform a statistical analysis over the structured data 122 in the data store 114 in connection with building a recommendation system 125. For instance, the analyzer component 124 may determine which terms co-exist across different records, frequency of co-existence of terms in the structured data 122, etc. A recommendation system, which can be any suitable recommendation system, may be built based at least in part upon such statistical analysis undertaken by the analyzer component 124.

The memory 108 may also comprise a receiver component 126 that is configured to receive a query issued by a user 128. In an example, the query is crafted by the user 128 to search for documents/records belonging to the domain to which the structured data 122 belongs. The query can be mapped to the domain based at least in part upon content of the query, explicit user action (e.g., indicating through a mouse click or spoken command a domain of interest to the user 128) through modeling the intent of the user 128 by way of known intent modeling techniques, or other suitable manners for determining that the user 128 wishes to utilize the queries to search documents/records belonging to the particular domain. In an example, the user 128 can issue the query to a general purpose search engine. In another example, the user can issue the query to a web site that corresponds to the particular domain.

The recommendation system 125 is in communication with the receiver component 126, receives the query issued by the user 128 and performs query expansion based at least in part upon the content of the query and the results of the statistical analysis undertaken by the analyzer component 124. Pursuant to an example, the recommendation system 125 may utilize algorithms commonly employed in recommendation systems, such as algorithms used in item to item recommendation systems, algorithms that utilize weights of evidence for recommendation, amongst any other suitable algorithms in connection with performing query expansion. In general, the recommendation system 125 can receive the user query and, given contents of the query, can ascertain what else the user 128 may be interested in based at least in part upon the content of the structured data 122 itself. This is markedly different from conventional approaches, which analyze queries previously proffered by users and do not consider the content of semi-structured data when performing query expansion.

In an example, query expansion that may be performed by the recommendation system 125 may include providing query alterations to the user 128, wherein such alterations can include additional terms to the query submitted by the user 128, substitute terms to the query submitted by the user 128, etc. These query alterations may include terms or phrases that would not have been otherwise contemplated by the user 128, since the user 128 may not have been aware of the content of the semi-structured data from the data sources 110-112 a priori.

The memory 106 may also optionally include a search component 132 that is configured to execute a search over a particular document corpus based upon the query provided by the user 128 or one or more of the alternate queries when such alternate queries are selected by the user 128. For instance, the search component 132 may be a general purpose search engine that is configured to search over an entirety of the World Wide Web through utilization of the query submitted by the user 128 or one or more of the query alterations are submitted by the user 128. The search component 132 may then be configured to provide the search results to the user 128. In another example, the search component 132 may be a search engine that is configured to be restricted to searching over documents on the World Wide Web that belong to the particular domain of interest. For instance, these documents may be labeled as belonging to the domain and the search component 132 can search over such documents using the query submitted by the user 128 and/or a query alteration selected by the user 128. In still yet another example, the search component 132 may belong to a particular web site, and the search component 132 may be configured to search over documents included in the web site (web pages belonging to the web site).

In still yet another example, the search component 132 may be restricted to searching the structured data 122 and returning one or more records to the user 128 that are included in the structured data 122. In this example, the search component 132 may be a general purpose search engine that is configured to search solely over the structured data 122 and provide the user 128 with one or more records included in the structured data 122 on a web page that belongs to the search engine. This may be useful to the search engine, as additional revenue may be generated via display of advertisements on the web page on which one or more of the records in the structured data 122 are displayed to the user 128.

Additionally, if the user 128 selects a query alteration output by the recommendation system 125, such query alteration may be provided back to the recommendation system 125, and the recommendation system 125 can output new query alterations based upon the statistical analysis utilized to build the recommendation system 125 and the new query selected by the user 128.

The exemplary computing apparatus 102 described above is shown to include multiple components in the memory 106. It is to be understood, however, that many of these components may be included in separate computing devices and/or across separate systems. For instance, the extractor component 108 and the formatter component 118 may be included in a first system that is configured to perform extraction of semi-structured data from data sources and transformation of the semi-structured data into structured data as described above. The analyzer component 124, receiver component 126, and recommendation system 125 may be included in a separate system that is configured to perform statistical analysis over the structured data. The search component 132 may reside on an entirely separate system and is configured to perform searches utilizing the query alterations generated by the recommendation system 125.

Additionally, the formatter component 118 was described as normalizing attributes in the structured data after the semi-structured data extracted from the data sources has been placed in a common schema. It is to be understood, however, that normalization may occur subsequent to the semi-structured data being extracted from the data sources 110-112 but prior to the semi-structured data being formatted in accordance with a common schema. It is thus to be understood that any suitable manner for generating structured data from semi-structured data extracted from a plurality of data sources is contemplated and intended to fall under the scope of the hereto appended claims.

Still further, the data store 114 is shown as being included in the computing apparatus 102. It is to be understood that the data store 114 may be the memory 106, or may be housed on a separate computing apparatus that is accessible to the computing apparatus 102. Other embodiments will be appreciated by one skilled in the art and are intended to fall under the scope of the hereto appended claims.

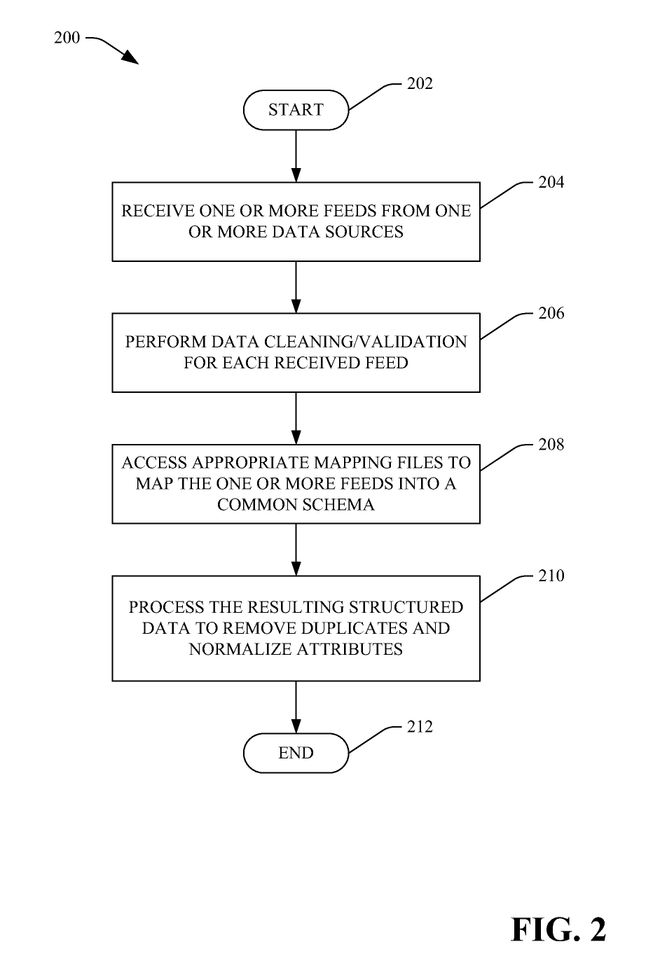

With reference now to FIGS. 2, 3, 7 and 8, various exemplary methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be a non-transitory medium, such as memory, hard drive, CD, DVD, flash drive, or the like.

Referring now to FIG. 2, a methodology 200 that facilitates generating structured data with respect to a particular domain is illustrated. The methodology 200 begins at 202, and at 204 one or more feeds from one or more data sources that include information belonging to a particular domain are received. These feed(s) include semi-structured data which has been described above.

At 206, data cleaning/validation is performed for each feed received at 204. Cleaning may include deleting data that is not desired, formatting data such that the data is more readily processable, etc.

At 208, appropriate mapping files are accessed to map the cleaned/validated data feed(s) into a common schema. This common schema may include a format/fields that is learned based at least in part upon an analysis of semi-structured data (e.g., learning which attributes are important to retain, learning desired location of such attributes, etc.).

At 210 the resulting structured data is processed to remove duplicate records therein and/or to normalize attributes/values included therein. The methodology 200 completes at 212.

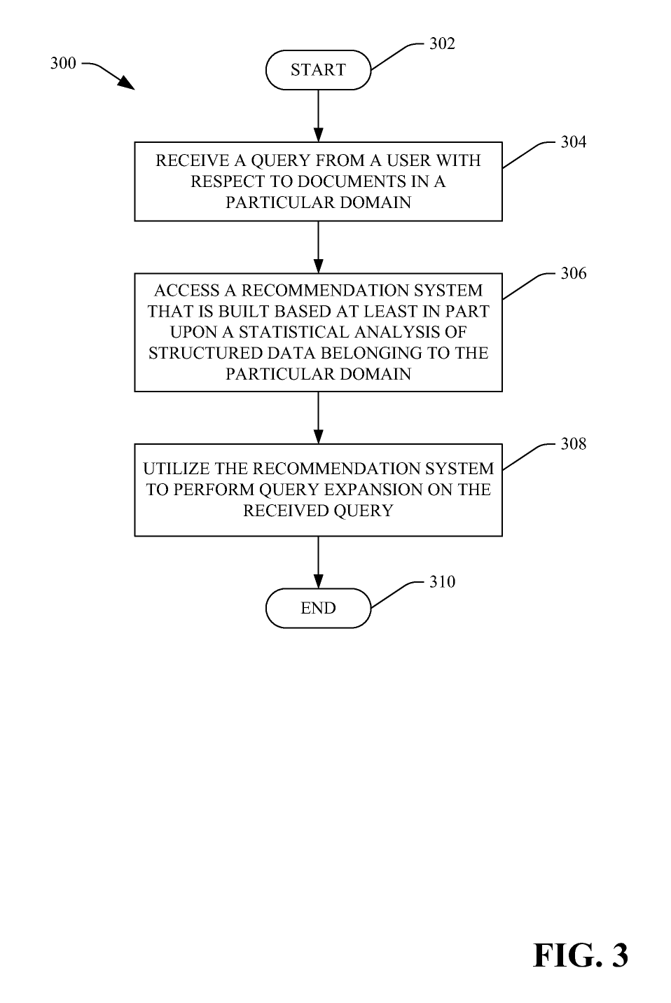

Referring now to FIG. 3, an exemplary methodology 300 that facilitates performing query expansions based at least in part upon statistical analysis of structured data is illustrated. The methodology 300 starts at 302, and at 304 a query from a user with respect to documents in a particular domain is received. For instance, a user issuing a query may wish to search for recipes, resumes, computing systems or other documents that include semi-structured data.

At 306, a recommendation system is accessed, wherein the recommendation system is built based at least in part upon a statistical analysis of structured data that belongs to the particular domain. For example, the structured data may be generated as described with respect to FIG. 2. At 308, the recommendation system is utilized to perform query expansion with respect to the query received at 304. Thus, the methodology 300 describes performing query expansion by treating query expansion as a recommendation problem. The methodology 300 completes at 310.

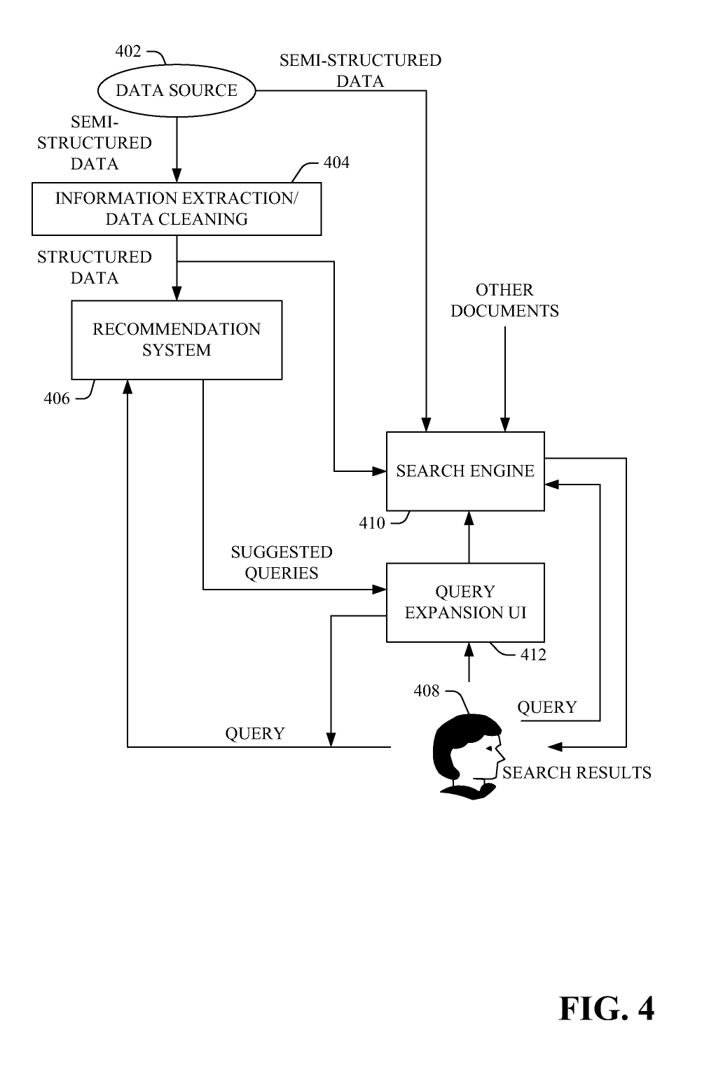

Now referring to FIG. 4, an exemplary system/flow diagram 400 is illustrated. A data source 402 can include/output semi-structured data. For instance, the data source 402 may be a web page, and the web page may include semi-structured data. At 404, information extraction/data cleaning is performed on the semi-structured data. This can be undertaken in accordance with acts of the methodology 200 described above. The result of the information extraction/data cleaning can be structured data, which can be utilized to build a recommendation system 406. For example, a statistical analysis can be undertaken with respect to the structured data to build the recommendation system 406. Thus, the recommendation system 406 is built based upon content of the semi-structured data from the data source 402.

A user 408 can proffer a query to a search engine 410, which can be configured to provide search results to the user 408 based at least in part upon the query. The search engine 310 can perform the search over the semi-structured data from the data source 402, the structured data mentioned above, and/or other documents. Additionally, the query proffered by the user 408 can be received by the recommendation system 406. The recommendation system 406 can output one or more suggested queries based at least in part upon the received query and the structured data upon which the recommendation system 406 is built. A query expansion user interface can receive the suggested queries, and can display such suggested queries to the user 408 (e.g., together with the search results output by the search engine 410). The user 408 may then select a suggested query, and such query can be provided to the search engine 410, which can return search results to the user 408 based at least in part upon the selected suggested query. Additionally, the suggested query can be received at the recommendation system 406, which can generate suggested queries based upon the suggested query selected by the user 408.

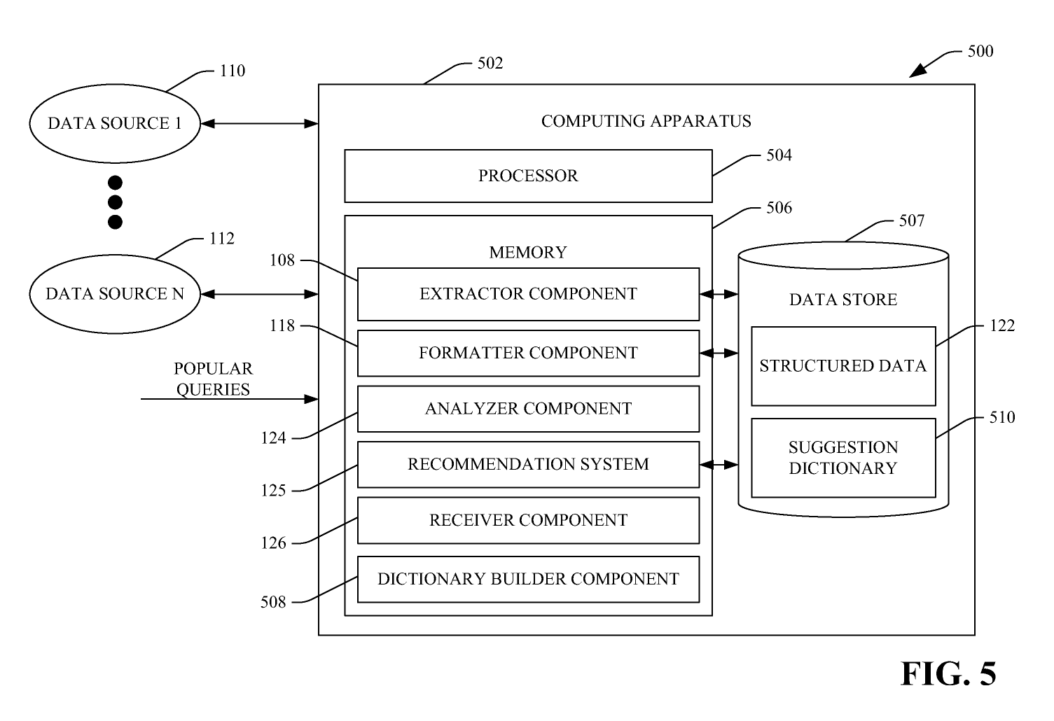

Referring now to FIG. 5, an exemplary system 500 that facilitates generating a suggestion dictionary based at least in part upon an analysis of structured data is illustrated. The system 500 includes a computing apparatus 502 that can comprise a processor 504 and a memory 506 that includes components that are executable by the processor 504. The memory 506 includes the extractor component 108 and the formatter component 118 that can act in conjunction to extract semi-structured data from the data sources 110-112 and process such data to generate the structured data 122 as described with respect to FIG. 1. The structured data 122 can be stored in a data store 507 included in the computing apparatus 502 or accessible to the computing apparatus 502. Again, this structured data 122 pertains to a particular domain.

The memory 506 may also include the analyzer component 124 that can perform a statistical analysis over the structured data 122 in connection with building the recommendation system 125 for the particular domain. The memory also includes the receiver component 126. In the exemplary system 500, the receiver component 126 is configured to receive a plurality of popular queries pertaining to the particular domain. The popular queries, for instance, may be included in query logs of a search engine. These popular queries can be selected using any suitable selection technique including determining a number of issuances of queries, monitoring search results selected upon issuance of a query by a user (to ascertain a domain corresponding to the query), amongst other techniques.

The popular queries may be received by the recommendation system 125, which can recommend altered queries to the popular queries. Pursuant to an example, these altered queries may be again provided to the recommendation system 125, which can output suggested queries to such altered queries. Such a cycle can be iterated any suitable number of times. Furthermore, in this exemplary system 500, the recommendation system 125 may be configured to map the popular queries and suggested queries to particular records in the structured data 122.

A dictionary builder component 508 can be configured to build a suggestion dictionary 510 based at least in part upon the recommendations output by the recommendation system 125. The suggestion dictionary 510 can include at least two columns: a first column that comprises queries (phrases), and a second column that comprises records that correspond to the queries. Pursuant to an example, each query included in the suggestion dictionary 510 can have at least one record corresponding thereto. It is to be understood, however, that a query/phrase included in the suggestion dictionary 510 may have multiple records corresponding thereto. The suggestion dictionary 510 can include the popular queries, as well as queries that are suggested by the recommendation system 125 upon receipt of such popular queries. The suggestion dictionary 510 can include these suggested queries as well as one or more records that are mapped to such suggested queries.

In addition to including or mapping a query to one or more records, the dictionary builder component 508 can cause the suggestion dictionary 510 to map one or more queries to one or more alternate queries output by the recommendation system 125. Still further, in addition to or in alternative to mapping a query to a record, the dictionary builder component 508 can cause a query to be mapped to a document that corresponds to the record. For instance, each record in the structured data 122 will have originated from at least one document in the data sources 110-112. The relationship between records and documents can be retained in the structured data 122 and can be included in the suggestion dictionary 510 if desired.

It can thus be understood that the dictionary builder component 508 can be configured to build the suggestion dictionary 510 in an offline system. The suggestion dictionary 510 may then be deployed in an online search system to enable the search system to ascertain mappings between records and queries, and/or to quickly ascertain alternate queries given a query received from a user, and/or to quickly locate documents pertaining to a query received from a user.

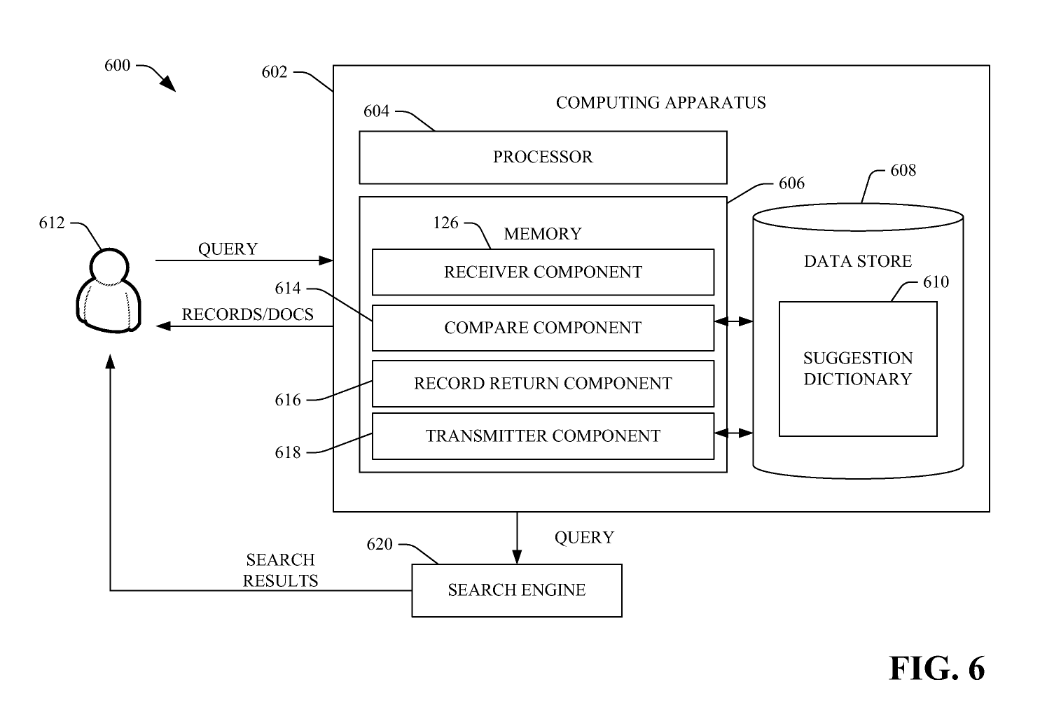

Referring now to FIG. 6, an exemplary system 600 that facilitates utilizing a suggestion dictionary to provide a user with at least one record and/or document is illustrated. The system 600 includes a computing apparatus 602 that comprises a processor 604 and a memory 606 that includes components that are executable by the processor 604. The computing apparatus 602 may also include a data store 608 that retains a suggestion dictionary 610 which can be created offline as described above.

The memory 606 includes the receiver component 126, which is configured to receive a query issued by a user 612. The memory 606 may further comprise a comparer component 614 that can access the data store 608 and compare entries in the suggestion dictionary 610 with the query issued by the user 612.

The memory 606 may also include a record return component 616 that can return records/documents corresponding to the query. More particularly, the comparer component 614 can determine that the query is included in the suggestion dictionary 610, and the record return component 616 can return records corresponding to such query in the suggestion dictionary 610. As discussed previously, the records provided to the user 612 may be records formatted in accordance with a common schema but formatted for display to the user 612 in an aesthetically pleasing manner. Additionally or alternatively, documents from which the records originated can be provided to the user 612 if the query is included in the suggestion dictionary 610.

In some instances the query submitted by the user 612 may not be included in the suggestion dictionary 610. The memory 606 may comprise a transmitter component 618 that can transmit the query issued by the user 612 to a search engine 620 if the query is not included in the suggestion dictionary 610. The search engine 620 may then utilize the query to execute a search over an appropriate document corpus and provide the user 612 with search results retrieved through utilization of such query. Pursuant to an example, the query can be retained in search logs of the search engine 620 and may be provided to the system 500 (FIG. 5) to update the suggestion dictionary 610 at a later point in time.

It can be understood that the system 600 provides many of the benefits of the query alteration system described herein without requiring an owner of the system 600 to have a recommendation system in place. Instead, the suggestion dictionary 610 is pre-computed and mapping between queries/phrases and records in structured data (and possibly alternate queries and/or documents from which the records originated).

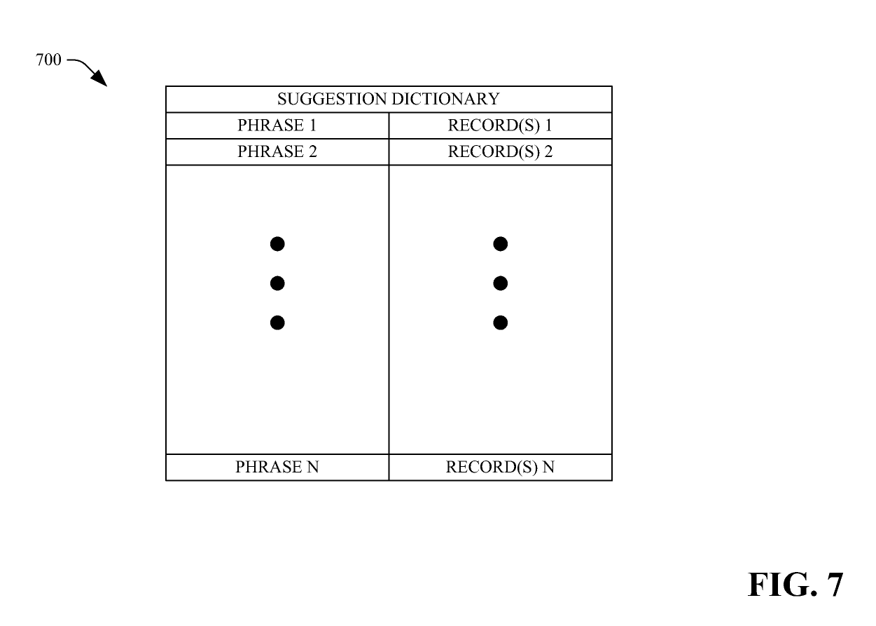

With reference to FIG. 7, an exemplary suggestion dictionary 700 is illustrated. The suggestion dictionary 700 may comprise at least two columns: a first column that includes phrases (phrase 1 through phrase N) and a second column that comprises records that correspond to the respective phrases (record(s) 1 through record(s) N). Thus, a first phrase is mapped to a first record or set of records in a structured data set, a second phrase is mapped to a second record or set of records in the structured data set, etc. The suggestion dictionary 700 may optionally include a column that comprises alternate queries with respect to the phrases in the first column. Thus phrase 1 may correspond to one or more alternate queries. Still further, the suggestion dictionary 700 may comprise a column that indicates documents from which the records originated. Accordingly, if the user issues a query that corresponds to the first phrase, the records in the suggestion dictionary 700 may be returned to the user and/or documents from which the records originated may be returned to the user.

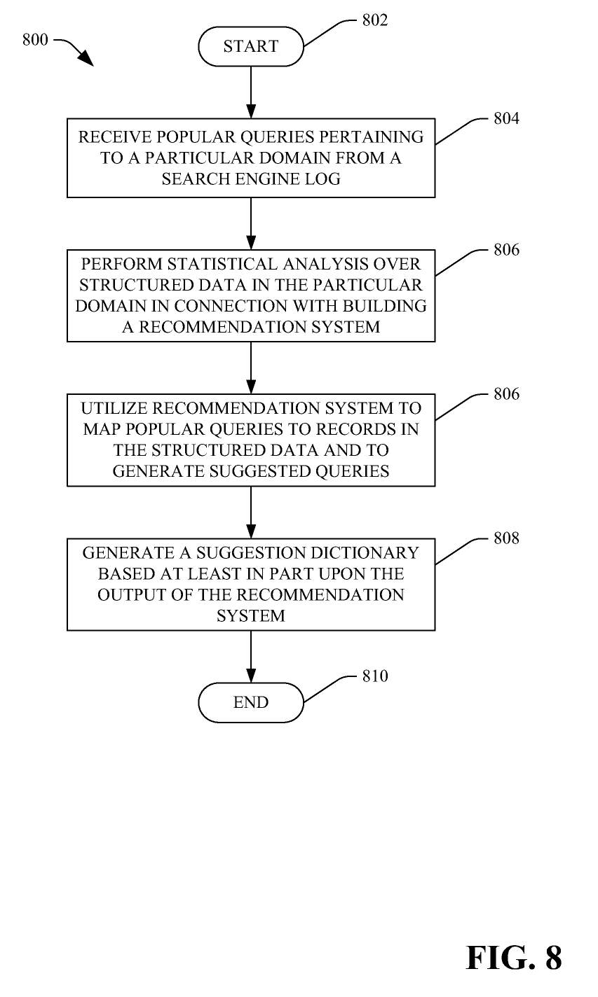

Turning now to FIG. 8, an exemplary methodology 800 that facilitates generating a suggestion dictionary offline is illustrated. The methodology 800 starts at 802, and at 804 popular queries pertaining to a particular domain are received from a search engine log. At 806, a statistical analysis is performed over structured data that correspond to the particular domain in connection with building a recommendation system. As indicated above, this statistical analysis may be utilized to learn which terms in structured records co-exist frequently, etc.

At 808, popular queries are provided to the recommendation system, which can map one or more records in the structured data to the popular queries and can further generate suggested queries based at least in part upon the popular queries.

At 810, a suggestion dictionary is generated based at least in part upon the output of the recommendation system. The methodology completes at 812.

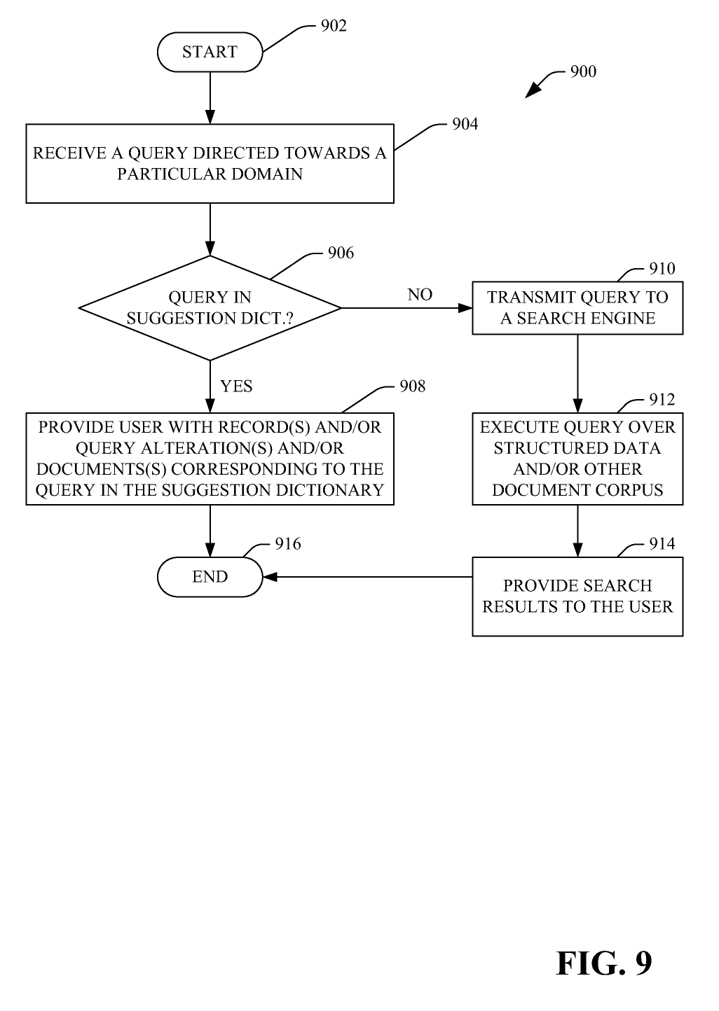

Referring now to FIG. 9, an exemplary methodology 900 that facilitates performing a search through utilization of a suggestion dictionary is illustrated. The methodology 900 starts at 902, and at 904 a query is received from a user, wherein the query is directed toward documents in a particular domain. For instance, the query may be directed for utilization in searching for recipes, resumes or other semi-structured data. At 906, a determination is made regarding whether the query received at 904 is in a pre-generated suggestion dictionary. If the query is included in the suggestion dictionary, then at 908 the user is provided with records and/or query alterations and/or documents (web pages) corresponding to the queries in the suggestion dictionary.

If at 906 it is determined that the query is not included in the suggestion dictionary, then at 910 the query is transmitted to a search engine. The search engine may be a general purpose search engine or a search engine configured to search documents with respect to a particular web site or special corpus documents.

The methodology then proceeds to 912, where the query is executed over the structured data and/or some other suitable document corpus. For instance, the query can be executed over each web page indexed by a general purpose search engine. At 914, the search results retrieved during a search that utilized the query are provided to the user. The methodology 900 completes at 916.

As can be ascertained from the above, statistical analysis over structured data can be utilized in connection with aiding a user in retrieving relevant information pertaining to a particular domain. Thus, a query can be received from a user, where the query is directed toward a particular domain. Data can be provided to the user subsequent to the query being received, wherein the data is provided for display on the display screen of a computing apparatus and the data is provided based at least in part upon a statistical analysis undertaken with respect to structured data pertaining to the particular domain. The data provided to the user may be alternate queries that are located through statistical analysis of the structured data or may alternatively be records or documents or alternate queries that are mapped to the received queries where the mapping is undertaken through statistical analysis of structured data.

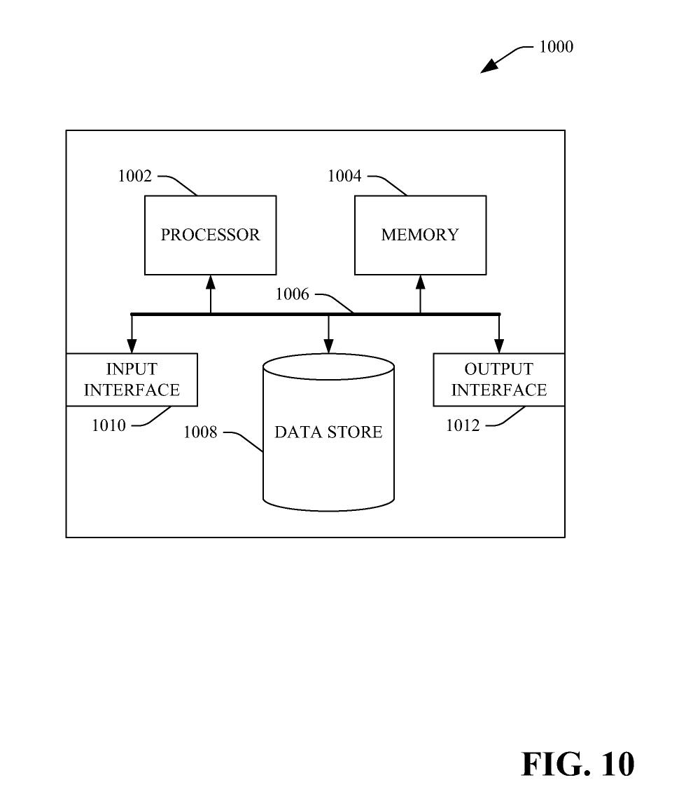

Referring now to FIG. 10, a high-level illustration of an exemplary computing device 1000 that can be used in accordance with the systems and methodologies disclosed herein is illustrated. For instance, the computing device 1000 may be used in a system that supports providing alternate queries to a user based upon a statistical analysis of structured data. In another example, at least a portion of the computing device 1000 may be used in a system that supports providing records and/or documents to a user based at least in part upon statistical analysis of structured data. The computing device 1000 includes at least one processor 1002 that executes instructions that are stored in a memory 1004. The memory 1004 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 1002 may access the memory 1004 by way of a system bus 1006. In addition to storing executable instructions, the memory 1004 may also store semi-structured data, structured data, mapping files, a suggestion dictionary, a schema, etc.

The computing device 1000 additionally includes a data store 1008 that is accessible by the processor 1002 by way of the system bus 1006. The data store 1008 may be or include any suitable computer-readable storage, including a hard disk, memory, etc. The data store 1008 may include executable instructions, structured data, semi-structured data, a suggestion dictionary, etc. The computing device 1000 also includes an input interface 1010 that allows external devices to communicate with the computing device 1000. For instance, the input interface 1010 may be used to receive instructions from an external computer device, from a user, etc. The computing device 1000 also includes an output interface 1012 that interfaces the computing device 1000 with one or more external devices. For example, the computing device 1000 may display text, images, etc. by way of the output interface 1012.

Additionally, while illustrated as a single system, it is to be understood that the computing device 1000 may be a distributed system. Thus, for instance, several devices may be in communication by way of a network connection and may collectively perform tasks described as being performed by the computing device 1000.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. Furthermore, a component or system may refer to a portion of memory and/or a series of transistors.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method comprising the following computer-executable acts:
receiving a query from a user, wherein the query is configured to search over a plurality of documents belonging to a particular domain; and
subsequent to receiving the query, providing data to the user for display on a display screen of a computing apparatus, wherein the data is provided based at least in part upon a statistical analysis undertaken with respect to structured data pertaining to the particular domain, wherein the structured data is based at least in part upon data included in the plurality of documents.

2. The method of claim 1, wherein the data provided to the user comprises an alternate query.

3. The method of claim 2, wherein the documents are web pages.

4. The method of claim 3, further comprising:
receiving a selection of the alternate query from the user;
causing a search to be performed over the plurality of web pages based at least in part upon the alternate query; and
providing results of the search to the user.

5. The method of claim 3, further comprising:
receiving a selection of the alternate query from the user;
causing the alternate query to be transmitted to a general purpose search engine; and
receiving search results from the general purpose search engine.

6. The method of claim 1 configured for execution in a general purpose search engine.

7. The method of claim 1 configured for execution on a website that comprises the plurality of documents.

8. The method of claim 1, wherein the structured data comprises a plurality of records, and wherein the data provided to the user comprises a record from the structured data.

9. The method of claim 8, further comprising:
comparing the query with a list of trigger phrases retained in a suggestion dictionary, wherein each trigger phrase in the suggestion dictionary has at least one record corresponding thereto;
determining that the query is included as a trigger phrase in the list of trigger phrases; and
providing the at least one record to the user that corresponds to the trigger phrase.

10. The method of claim 1, further comprising:
extracting semi-structured data from the plurality of documents; and
processing the semi-structured data from the plurality of documents to generate the structured data.

11. The method of claim 10, wherein processing the semi-structured data comprises:
causing the semi-structured data from a plurality of different data sources to conform to a common schema.

12. The method of claim 10, wherein processing the semi-structured data comprises:
removing duplicate records from the semi-structured data; and
normalizing the semi-structured data.

13. A computing apparatus, comprising:
a processor; and
a memory that comprises components that are executable by the processor, the components comprising:
a receiver component that receives a query from a user, wherein the query is configured by the user to retrieve one or more documents belonging to a particular domain; and
a recommendation system that performs query expansion based at least in part upon the query received from the user and a statistical analysis of structured data extracted from a plurality of documents belonging to the particular domain.

14. The computing apparatus of claim 13, wherein the recommendation system is configured to provide the user with a suggested query.

15. The computing apparatus of claim 13, wherein the plurality of documents are web pages.

16. The computing apparatus of claim 13, wherein the plurality of documents comprise semi-structured data.

17. The computing apparatus of claim 16, wherein the components further comprise:
an extractor component that extracts the semi-structured data from the plurality of documents; and
a formatter component that processes the semi-structured data to generate the structured data.

18. The computing apparatus of claim 13, wherein the plurality of documents are generated by a plurality of different data sources.

19. The computing apparatus of claim 13, wherein the components further comprise a search component that is configured to execute a search over the one or more documents utilizing the received query or an alternate query that is based at least in part upon the received query.

20. A computer-readable medium comprising instructions that, when executed by a processor, cause the processor to perform acts, comprising:
extracting semi-structured data from a plurality of web pages that comprise content pertaining to a particular domain, wherein the plurality of web pages correspond to a plurality of different data sources;
processing the semi-structured data to generate structured data, wherein the structured data comprises a plurality of records, and wherein the plurality of records have a common format;
generating a suggestion dictionary based at least in part upon a statistical analysis of the structured data, wherein the suggestion dictionary comprises a list of phrases, wherein each phrase in the list of phrases has at least one record from the structured data that corresponds thereto;
receiving a query from a user that is configured to retrieve search results in the particular domain;
comparing the query with phrases in the suggestion dictionary; and
if the query is included as a phrase in the suggestion dictionary, returning to the user the at least one record that corresponds to the phrase.
